(19) United States
(12) Patent Application Publication
(10) Pub. No.: US 2010/0004960 A1
(43) Pub. Date: Jan. 7, 2010

(54) METHOD AND ARRANGEMENT OF DEVICES FOR OPERATING AN ELECTRONIC PARCEL POSTBOX

(75) Inventors: Steffen Frankenberg, Rheinbach (DE); Flavio Alario, Bonn (DE); Rebekka Alario, Bonn (DE)

Correspondence Address: International IP Law Group, P.O. BOX 691927, HOUSTON, TX, 77269-1927, US

(73) Assignee: Deutsche Post AG, Bonn (DE)

(21) Appl. No.: 12/514,015

(22) PCT Filed: Nov. 9, 2007
(86) PCT No.: PCT/EP2007/009718

§ 371 Date: May 7, 2009

(30) Foreign Application Priority Data
Nov. 13, 2006 (EP) 06023553.8

(51) Int. Cl. G06Q 50/00; G06Q 10/00; G06Q 30/00

(52) U.S. Cl. 705/5; 705/8

(57) ABSTRACT

There is provided a system and method for operating at least one electronic parcel compartment facility. The parcel compartment facility comprises several compartments in a number amounting to F, with which mailpieces of at least two user groups A and B having different access rights can be deposited into the compartments of the parcel compartment facility, whereby the parcel compartment facility is in communication with a central data processing unit. The occupation status of the compartments of the parcel compartment facility is transmitted to the data processing unit so that the number Y of different sizes of free compartments of the parcel compartment facility is stored in a memory of the data processing unit. The central data processing unit is also in communication with at least one mail distribution center where destination information about the mailpieces is acquired, whereby the destination information is associated with the parcel compartment facility. An exemplary method comprises specifying a period of time Z between a starting point in time and an ending point in time and storing the period of time Z in a data processing unit of the mail distribution center. The exemplary method also comprises acquiring destination information and sizes of the mailpieces in the mail distribution center using a data acquisition device. The exemplary method additionally comprises determining the X number of mailpieces whose destination information acquired during the period of time Z matches the destination information of the parcel compartment facility by the data processing unit of the mail distribution center and transmitting the number X by the data processing unit of the mail distribution center to the central data processing unit. The exemplary method further comprises comparing the number X to the number Y of free compartments and assigning X free compartments of the parcel compartment facility to a first user group A by the central data processing unit if Y≧X. The exemplary method also comprises transmitting a control command for the reservation of the X free compartments of the parcel compartment facility assigned to the first user group A by the data processing unit to a control unit of the parcel compartment facility, and subtracting the number X of reserved compartments from the number Y of free compartments for purposes of determining the number V of available compartments remaining in the parcel compartment facility. The exemplary method additionally comprises assigning at least some of the remaining available compartments V to a second user group B, if V>1 and transmitting a control command for a reservation of the compartments assigned to the second user group B from the data processing unit to the control unit of the parcel compartment facility. The exemplary method further comprises acquiring user identifications and/or mailing information through a user interface at the parcel compartment facility and associating a user and/or a mailpiece with the user groups A or B on the basis of the acquired user information and/or mailing information. The exemplary method also comprises controlling access to free compartments of the parcel compartment facility on the basis of the reservations made for the two user groups A and B and determining a point in time P by the control unit of the parcel compartment facility. The exemplary method additionally comprises canceling the reservations of compartments for the user groups A and B after the point in time P and releasing access to free compartments of the parcel compartment facility to all user groups.

### CROSS REFERENCE TO RELATED APPLICATIONS

Pursuant to 35 U.S.C. § 371, this application is the United States National Stage Application of International Patent Application No. PCT/EP2007/009718, filed on Nov. 9, 2007, the contents of which are incorporated by reference as if set forth in their entirety herein, which claims priority to European (EP) Patent Application No. 06023553.8, filed Nov. 13, 2006, the contents of which are incorporated by reference as if set forth in their entirety herein.

### BACKGROUND

Various systems are known from the state of the art in which multiple users have access to an electronic locker compartment facility that can be used to deposit and pick up objects. The systems can be, for example, postal shipping systems or merchandise systems. In the case of postal shipping systems, for example, the possibility exists not to deliver parcels to the home address of a recipient but rather, to deposit them into a compartment of a given parcel compartment facility. The recipient of the shipment can then pick up the parcel at the parcel compartment facility at his/her own convenience. Also in the case of merchandise systems, the ordered or purchased merchandise can be deposited into a suitable locker compartment facility, so that the customer can pick up the merchandise at the facility at his/her own convenience. This is particularly practical for purchases made through the Internet.

The users of such a locker compartment facility are normally at least several recipients of parcels or other merchandise shipments. This user group is normally given access to compartments of the locker compartment facility by using one-time or permanent access codes. In this context, the recipients gain access, for example, to a compartment where a parcel addressed to them has been deposited, so that they can remove the parcel. Users of this user group, however, can also be given access to free compartments of a parcel compartment facility, for instance, to deposit return shipments.

Other user groups are normally deliverers or vendors, who deposit objects into free compartments of the locker compartment facility. In this context, various procedures can likewise be carried out at the locker compartment facility. Particularly in postal shipping systems that use parcel compartment facilities as an alternative delivery address, it is common practice to address the mailpieces directly to a parcel compartment facility. The destination information for these mailpieces is acquired ahead of time in a mail distribution center and the mailpieces are sorted on the basis of the destination information and then transported to the appropriate delivery base. Subsequently, the mailpieces are given to a deliverer who transports the mailpiece(s) to the appropriate parcel compartment facility and deposits each mailpiece into a free compartment of the parcel compartment facility.

Furthermore, mailpieces that had originally been addressed to the home address of a recipient but for which re-routing instructions were ascertained requesting delivery to a certain parcel compartment facility can also be placed into a parcel compartment facility. In another case, a deliverer transports a mailpiece to the home address of a recipient but ascertains there that the recipient is not at home, and the deliverer then leaves a notification for the recipient indicating that his/her mailpiece will be deposited into a parcel compartment facility instead. The deliverer then transports the mailpiece to the selected parcel compartment facility and likewise deposits it into a free compartment of the facility.

In order to utilize the capacities of parcel compartment facilities as efficiently as possible, in another modality of use of such a facility, it can be provided that not only mailpieces can be placed into a parcel compartment facility but that compartments that remain free can also be employed by vendors to deposit or deliver merchandise.

For instance, international patent application WO 01/31593 A1 discloses a delivery system in which merchandise—preferably ordered via the Internet—can be placed into a locker compartment facility and then retrieved from this facility by the recipients. The system can also be used by several vendors, delivery companies and recipients of merchandise.

If multiple groups of users are given access to one of more locker compartment facilities in this manner, it is necessary to properly allocate the capacities of the locker compartment facility in question. In this context, it can be provided, for example, that after merchandise has been ordered through the Internet, a certain compartment of a locker compartment facility is reserved for the delivery of this merchandise. This reservation is normally done via a central data processing unit that is in communication with the locker compartment facility and that has information about the occupation status of the compartments of the facility. Thus, it is ensured that a compartment will be available for the delivery of the ordered merchandise and that only the remaining compartments will be made available to the user groups that employed other delivery modalities.

This approach, however, is usually not suitable for the delivery of mailpieces since either the sender or the recipient of the mailpiece would already have to have reserved a compartment when the mailpiece was sent. Consequently, it is common practice for postal shipments to employ statistical empirical values in order to determine the projected number of mailpieces that will be deposited into a parcel compartment facility on a given day and to reserve the corresponding number of compartments. In this case, likewise only the remaining compartments are made available to the user groups that employ the other delivery modalities.

In actual practice, it has been found that this type of capacity planning is actually very imprecise and does not ensure optimal utilization of the capacity of a locker compartment facility.

### SUMMARY OF THE INVENTION

An exemplary embodiment of the present invention relates to a method for operating at least one electronic parcel compartment facility comprising several compartments, whereby, with this method, mailpieces of at least two user groups having different access rights can be deposited into the compartments of the parcel compartment facility. The parcel compartment facility is in communication with a central data processing unit, and the occupation status of the compartments of the parcel compartment facility is transmitted to the data processing unit so that the number of free compartments of the parcel compartment facility is stored in a memory of the data processing unit. The central data processing unit is also in communication with at least one mail distribution center where destination information about the mailpieces is acquired, whereby the destination information is likewise associated with the parcel compartment facility.

An exemplary embodiment of the present invention also relates to an arrangement of devices for carrying out the method.

In addition, an exemplary embodiment of the present invention may relate to a method for operating a parcel compartment facility with which at least two user groups have access to free compartments of the parcel compartment facility and which achieves a better utilization of the capacity of the parcel compartment facility. In particular, the user groups have access to compartments of different sizes in the parcel compartment facility.

Another exemplary embodiment of the present invention relates to an arrangement of devices to carry out the method.

With the method according to an exemplary embodiment of the present invention for operating at least one electronic parcel compartment facility encompassing several compartments amounting to the number F, mailpieces of at least two user groups A and B having different access rights are deposited into the compartments of the parcel compartment facility. In this context, the parcel compartment facility is in communication with a central data processing unit, and the occupation status of the compartments of the parcel compartment facility is transmitted to the parcel compartment facility so that the number Y of different sizes of free compartments of the parcel compartment facility is stored in a memory of the data processing unit. The central data processing unit is also in communication with at least one mail distribution center where destination information of the mailpieces is acquired, whereby the parcel compartment facility is likewise associated with destination information.

An exemplary embodiment of the present invention provides that a period of time Z between a starting point in time and an ending point in time is specified, and this period of time is stored in a data processing unit of the mail distribution center. The destination information and the sizes of the mailpieces are acquired in the mail distribution center with a data acquisition device, and the X number of mailpieces whose destination information acquired during the period of time Z matches the destination information of the parcel compartment facility is determined by the data processing unit of the mail distribution center. Subsequently, this number X is transmitted by the data processing unit of the mail distribution center to the central data processing unit. The central data processing unit compares the number X to the number Y of free compartments of the parcel compartment facility. If Y≧X, then X free compartments of the parcel compartment facility are assigned to a first user group A by the central data processing unit. A control command for the reservation of the X free compartments of the parcel compartment facility assigned to the first user group A is transmitted by the data processing unit to a control unit of the parcel compartment facility.

Moreover, the central data processing unit subtracts the number X of reserved compartments from the number Y of free compartments for purposes of determining the number V of available compartments remaining in the parcel compartment facility. If this calculation shows that V>1, then the central data processing unit assigns at least some of the remaining available compartments V to a second user group B. A control command for a reservation of the compartments assigned to the second user group B is likewise transmitted from the data processing unit to the control unit of the parcel compartment facility.

In another step of the method according to an exemplary embodiment of the present invention, user identifications and/or mailing information are acquired through a user interface at the parcel compartment facility, and the control unit of the parcel compartment facility associates a user and/or a mailpiece with the user groups A or B on the basis of the acquired user information and/or mailing information. The control unit of the parcel compartment facility controls the access to free compartments of the parcel compartment facility on the basis of the reservations made for the two user groups A and B. Moreover, a point in time P is determined by the control unit of the parcel compartment facility. After the point in time P, the reservations of free compartments for the user groups A and B are cancelled by the control unit and the control unit releases access to free compartments of the parcel compartment facility for all user groups.

In an especially preferred exemplary embodiment of the invention, mailpieces of three user groups A, B and C can be deposited into the compartments of a parcel compartment facility, and a first portion of the remaining available compartments V is assigned to a second user group B, while a second portion of the remaining available compartments V is assigned to a third user group C. Here, the remaining available compartments V can be assigned to the user groups B and C in either equal or unequal proportions.

In an exemplary embodiment of the invention, the point in time P is permanently stored in the control unit of the parcel compartment facility. As an alternative, the point in time P can be specified variably as a function of various parameters. In both cases, the point in time P can be specified, for example, by the central data processing unit and transmitted to the control unit of the parcel compartment facility.

An exemplary embodiment of the present invention also encompasses an arrangement of devices to operate at least one electronic parcel compartment facility that is adapted to carry out the method according to an exemplary embodiment of the present invention.

One advantage of an exemplary embodiment of the present invention may relate to the improved utilization of the capacity of a parcel compartment facility. Owing to the transmission of the information about the free compartments of the parcel compartment facility to the central data processing unit and owing to the acquisition of mailing information in a mail distribution center, it can be ascertained at a very early point in time of the transportation and delivery process of a given mailpiece whether a free compartment is available for that mailpiece. Moreover, compartments can be reserved with great precision for mailpieces addressed directly to the parcel compartment facility. This is considerably more precise than a statistical prognosis based on empirical values, so that only the exact number of compartments that are needed are actually reserved. If re-routed mailpieces are likewise ascertained, this further increases the precision of the capacity planning.

For mailpieces or merchandise deliveries that can arrive at the parcel compartment facility via other delivery modalities, contingents of free compartments can be assigned according to prescribed criteria. Since the volume of such shipments cannot be determined in advance as precisely as can be done with the number of addressed directly mailpieces, the invention provides for the cancellation of all reservations after a certain point in time. In this manner, if too many compartments have been reserved for a user group on a given day, this reservation is not retained and does not block the placement of other mailpieces, but rather, the principle of “first come, first served” applies after a certain point in time, as a result of which the utilization of the capacity of the parcel compartment facility can be improved.

### BRIEF DESCRIPTION OF THE DRAWING

The figures show the following:

FIG. 1 is a block diagram of an arrangement of devices according to an exemplary embodiment of the present invention; and

FIG. 2 is block diagram that is useful in explaining the dividing of a delivery process among two mail distribution centers according to an exemplary embodiment of the present invention.

### DETAILED DESCRIPTION OF SPECIFIC EMBODIMENTS

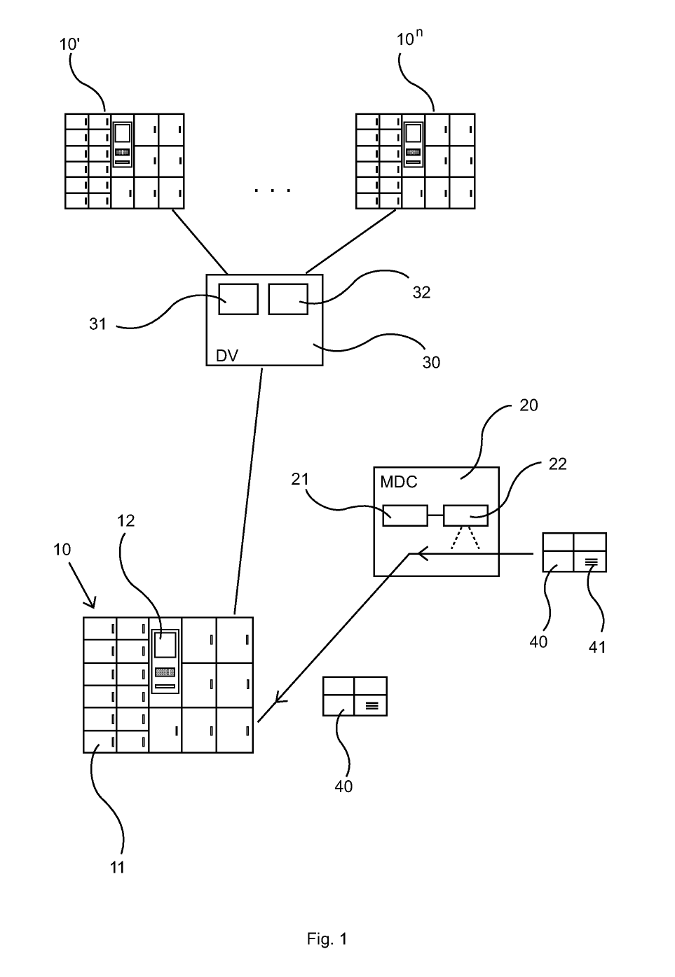

The method according to an exemplary embodiment of the present invention and an exemplary arrangement of devices for carrying out the method are explained on the basis of the exemplary embodiment shown in FIG. 1.

The arrangement according to an exemplary embodiment of the present invention provides for at least one parcel compartment facility 10 that is in communication with a central data processing unit 30. This connection can be temporary or permanent and can be established, for instance, by using phone, Internet or radio connections. The data processing unit 30 is preferably located at a distance from the parcel compartment facility.

A parcel compartment facility is preferably set up in a public place and it consists of a housing in which several compartments are accommodated. The facility can be configured in different ways. For example, it can be a conventional facility having several compartments that are each closed with a door of their own. Each door has a locking mechanism that can be actuated by a central control unit of the parcel compartment facility.

In another exemplary embodiment of a parcel compartment facility, the facility functions according to the paternoster principle in which one of several storage compartments can be moved by a transport mechanism and positioned in front of an opening that has a lockable door. The locking mechanism of the door is likewise in communication with a central control unit of the parcel compartment facility. Moreover, the control unit also regulates the movement of the storage compartments within the facility, so that selected storage compartments can be positioned in front of the opening. In any case, a parcel compartment facility comprises F compartments into which objects such as mailpieces can be placed.

A parcel compartment facility normally has a user interface 12 for interaction with a given user. The user interface can comprise various components. In a practical manner, it contains at least a screen where information can be displayed. The screen can also be configured in the form of a touch screen, so that a user can input data via the screen. If no touch screen function is employed, a keypad can be provided for purposes of inputting information. The user interface can also comprise a card reader. The reader can read credit cards as well as user cards. The credit card function can be used, for instance, for the payment of COD charges. User cards can be read for purposes of identifying users.

The user interface 12 is advantageously in communication with the control unit (not shown in FIG. 1) of the parcel compartment facility. Once a customer has entered, for example, an access code at the user interface, the code is checked and a positive result generates a control signal such that the control unit opens a selected or assigned compartment. For this purpose, the user interface and the control unit are in communication with the data processing unit (likewise not shown in FIG. 1) that can compare data, can reserve compartments and can release compartments.

Preferably, additional parcel compartment facilities 10′ to 10ⁿ are in communication with the central data processing unit 30. The data processing unit comprises at least one memory 31 in which the occupation status of the compartments of all of the connected parcel compartment facilities is stored. As soon as an object is placed into or removed from a compartment of a parcel compartment facility, this information about the changed occupation status of a compartment is transmitted to the central data processing unit. Here, in a first exemplary embodiment, a precise association of an occupation status with a specific compartment can be made. In a second exemplary embodiment, the number of free or occupied compartments is merely increased or decreased, so that there is no association of an occupation status with a specific compartment.

The change in the occupation status can be transmitted immediately after the occurrence of the event or else at pre-specified points in time. In any case, it has proven to be practical to transmit the occupation status to the data processing unit as promptly as possible so that the data processing unit 30 is continuously informed about the current occupation status of all of the connected parcel compartment facilities. If necessary, a query about the occupation status at a given parcel compartment facility can also be made at any desired point in time. Thus, at a given point in time, the number Y of free compartments of the parcel compartment facility in question is available to the data processing unit, and the number Y is stored, for example, in the memory 31 of the data processing unit.

The central data processing unit 30 is also in communication with at least one mail distribution center 20. Mailpieces 40 of a given delivery district are brought to the mail distribution center so that they can be sorted and forwarded for delivery once they have been collected from collection sites such as post office branches or from mailboxes or parcel boxes. As an alternative, these mailpieces are picked up from the premises of a sender or dropped off by the latter at the mail distribution center. A data acquisition unit 22 at the mail distribution center 20 acquires the destination information of each passing mailpiece.

The data acquisition unit 22 can be, for instance, an OCR reading device with which graphic information located on the mailpieces can be acquired and evaluated, and with which the size of the mailpieces can be ascertained. If the destination information on a mailpiece is already encrypted in the form of a barcode, barcode scanners can also be employed as the data acquisition unit.

A mailpiece that has been sorted on the basis of its destination information is subsequently transported to a delivery base and given to a deliverer who transports the mailpiece to the parcel compartment facility with which the destination information is associated. The data acquisition unit 22 in the mail distribution center 20 is also in communication with another data processing unit 21 that evaluates the acquired destination information. The evaluation especially includes the determination of the X number of mailpieces detected during a period of time Z, whose acquired destination information matches the destination information of an appertaining parcel compartment facility 10. For this purpose, the period of time Z between a starting point in time and an ending point in time is specified and this period of time Z is stored in a data processing unit 21. The period of time is normally a certain number of hours of a day during which mailpieces intended for delivery on the same day are recorded. Towards this end, the data processing unit 21 has a clock function.

The period of time Z can be specified by the data processing unit 21 of the mail distribution center 20 or by the central data processing unit 30. In the latter case, information for specifying the period of time Z can be transmitted by the data processing unit 30 to the data processing unit 21 of the mail distribution center. The data processing unit 21 counts of all of the parcel shipments that are intended for delivery to a parcel compartment facility and/or individually counts all of the parcel shipments that are addressed to a given parcel compartment facility 10, 10′, . . . 10ⁿ.

The mailpieces recorded during the period of time Z can be not only mailpieces that are addressed directly to the parcel compartment facility but also mailpieces for which applicable re-routing instructions were ascertained in the mail distribution center. Re-routing instructions given by recipients are stored, for example, in a database 32 of the central data processing unit 30 and can be called by the latter. If re-routing instructions have been ascertained for a given recipient, the mailpieces are re-addressed on the basis of this new destination information. Finally, the number X of mailpieces that are intended for delivery to a parcel compartment facility 10 is ascertained.

The ascertained number X is transmitted by the data processing unit 21 of the mail distribution center 20 to the central data processing unit 30. The data processing unit performs a comparison of the number X of compartments needed for the recorded mailpieces to the number Y of free compartments of the parcel compartment facility in question. As a result of the fact that the occupation status is being transmitted continuously, the current number Y is already present in the data processing unit 30 or else it is ascertained at that moment through a query to the parcel compartment facility in question.

If the comparison carried out by the data processing unit 30 reveals that the destination parcel compartment facility has sufficient free compartments, that is to say, if Y≧X, then the corresponding X number of compartments is reserved for a first user group A. This first user group A consists of deliverers who deposit shipments into the facility that are addressed directly to the parcel compartment facility or that have been re-addressed as a result of re-routing instructions. The reservation can include the permanent occupation of certain compartments or only the reservation of a number of compartments having the appropriate size, and appertaining control commands are transmitted to the control unit in the parcel compartment facility.

In order for the deliverers of this user group A to be identified at the parcel compartment facility, these deliverers have, for instance, special identification credentials such as access codes or user cards. When a deliverer arrives at the parcel compartment facility he/she identifies himself/herself and, on the basis of the identification, membership in a user group is ascertained. If he/she belongs to user group A, then one or more of the X reserved and free compartments are made available for him/her to deposit his/her mailpieces. In other words, the control unit of the parcel compartment facility allows access to permanently reserved compartments or to any number of reserved compartments.

An exemplary embodiment of the present invention also encompasses an embodiment in which a user is associated with a user group indirectly in that information is acquired from a mailpiece. In this case, the mailpieces that are addressed directly to the parcel compartment facility or that have been re-addressed as a result of re-routing instructions, are provided, for instance, with a set of numbers that associates the mailpiece with this particular delivery modality. In this case, the deliverer arrives at the parcel compartment facility and scans the set of numbers of a mailpiece. This can be done, for example, by scanning a barcode found on the mailpiece. The set of numbers is evaluated by the data processing unit of the parcel compartment facility, as a result of which the mailpiece can be associated with a given delivery modality and thus indirectly with the user group A, after which a compartment reserved for this user group is released so that the mailpiece can be deposited into it. If the scanned mailing information does not belong to the set of numbers that is associated with the reserved compartments of user group A, the deliverer is not given access to the X reserved compartments.

As soon as the central data processing unit 30 has ascertained an X number of compartments to be reserved for user group A, a computation device subtracts this number X from the number Y of free compartments that had previously been available in the parcel compartment facility 10. If the computation procedure Y−X=V reveals that additional free compartments are available in the parcel compartment facility after the reservation, that is to say, if V>0, then at least a portion of this number V of remaining free compartments is assigned to a second user group B. The assigned compartments are reserved for this user group and appropriate control commands are transmitted to the control unit in the parcel compartment facility.

The second user group B can be, for instance, registered customers who can place mailpieces into a parcel compartment facility, so that these mailpieces can then be picked up by personnel of a postal shipping system and transported to the destination address. They can be, for instance, return shipments from original recipients or else mailpieces that have to be newly franked and mailed. When a customer belonging to user group B arrives at the parcel compartment facility, her/she uses the user interface to identify himself/herself or the mailpiece to be deposited so that the data processing unit of the parcel compartment facility can ascertain with which user group the user or the mailpiece is associated. If compartments have been reserved for user group B, the customer is given access to a free compartment. The association with the user group B can also be effectuated by identifying the customer or by scanning the mailing data. For instance, the mailpieces to be deposited can be provided by a customer with a return or shipment label that contains a barcode consisting of a specific set of numbers. Such mailpieces usually are not recorded ahead of time in a mail distribution center. However, it can also be provided that a sender can announce his/her mailpiece in advance at the central data processing unit. This can be done, for example, via the Internet, so that the data processing unit can utilize this information to make a prognosis of the shipments that can be expected. As a function of this advance information, it is possible, for instance, to determine the portion of free compartments that will be reserved for user group B.

User group B can also be vendors who are allowed to use compartments of the postal parcel compartment facility in order to deposit merchandise ordered by their customers. This merchandise is normally not previously recorded in a mail distribution center, but rather, it reaches the parcel compartment facility via separate logistical modalities. However, the possibility exists that vendors can likewise have information about free compartments of the parcel compartment facility and can make reservations. These shipments can also be categorized by their own sets of numbers or by the corresponding identification of the deliverer of the vendor in question and can be recognized at the parcel compartment facility.

User group B can also be deliverers who had previously attempted to deliver a mailpiece to the home address of a recipient. If the recipient is not at his/her home address, the deliverer leaves a notification card at the recipient's address indicating the parcel compartment facility where the deliverer is going to deposit the mailpiece instead. For this purpose, information about the current occupation status and about reservations of each parcel compartment facility can be provided to the deliverer via a handheld device. The information about free and/or reserved compartments can be provided by each parcel compartment facility itself or by the central data processing unit 30. In a practical manner, this query is likewise made by associating the deliverer with its user group so that it can be ascertained whether free compartments are available, in other words, have been reserved, for this user group in a parcel compartment facility. For instance, it can be the case that free compartments are available in a parcel compartment facility selected by the deliverer but that these compartments are completely reserved on this day for directly addressed or re-routed mailpieces of user group A, or else that the contingent of compartments that were reserved for the user group of this deliverer has already been fully utilized by other deliverers.

In an exemplary embodiment of the invention, a compartment is reserved for the deliverer using the handheld device of the deliverer. For this purpose, the handheld device communicates with the selected parcel compartment facility or with the central data processing unit 30 and a reservation is made. If, for example, a total of 10 compartments has been reserved for user group B, one compartment is specially reserved so that the parcel for which a notification was left can be deposited and the compartment cannot meanwhile be given to other users belonging to user group B.

Therefore, the deliverer locates a parcel compartment facility having free capacities for his/her user group and deposits the shipment into the facility in question. In this process, he/she identifies himself/herself or the mailpiece at the user interface of the parcel compartment facility, after which the deliverer can be associated with a user group. Free compartments of the deliverer's user group are then made available to him/her. Normally, the notification card left at the recipient's address contains not only information about the parcel compartment facility but also an access code with which the mailpiece can be picked up by the recipient.

Thus, in the described exemplary embodiments, free compartments of a parcel compartment facility may be distributed among two user groups A and B. All of the requisite compartments are reserved for the user group A for directly addressed and re-routed mailpieces that have been recorded in a mail distribution center. The remaining free compartments are available to all other deliverers.

In another exemplary embodiment of the invention, the number V of free compartments that remain available after the reservation of X free compartments for the mailpieces that were recorded in the mail distribution center are then distributed among at least two other user groups B and C. For example, vendors still belong to the user group B, whereas deliverers of mailpieces that cannot be delivered to a recipient's address belong to user group C. Another subdivision of users having different priorities can be taken into consideration when the compartments are being made available.

The remaining available compartments V are thus distributed among the possible user groups according to a prescribed system and appropriate reservations are made. The distribution system can provide, for example, that approximately the same number of compartments is reserved for each user group. In another exemplary embodiment of the invention, individual user groups are given preference, so that the available compartments are reserved in equal numbers.

FIG. 1 shows only a mail distribution center 20. Preferably, however, several mail distribution centers are provided in a postal shipping system and these centers geographically cover the entire area of the mail transportation and distribution system.

Consequently, a mailpiece can pass through several mail distribution centers during its delivery. In order to plan capacity utilization and to make reservations, mailing information can be acquired at various stations and can then be appropriately used.

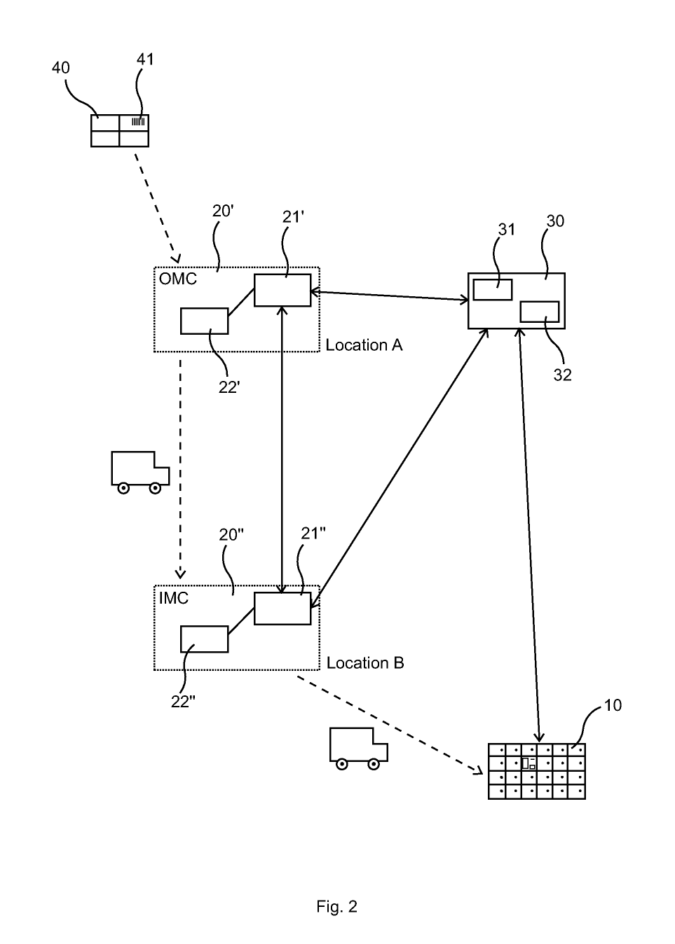

In this context, a mail distribution center can typically function both as a so-called incoming mail center IMC and as an outgoing mail center OMC. Such an arrangement of mail distribution centers is shown schematically in FIG. 2. When a mailpiece is dropped off by a customer at a location A and is to be delivered to a destination address at a location B, the mail distribution center 20′ in the vicinity of location A constitutes the outgoing mail center, whereas a mail distribution center 20″ at location B constitutes the incoming mail center. Conversely, if a mailpiece is dropped off at location B and is to be delivered to location A, the mail distribution center 20″ in the vicinity of location B functions as the outgoing mail center, whereas the mail distribution center 20′ at location A functions as the incoming mail center.

Normally, in a mail distribution center that functions as an incoming mail center IMC, the destination information about each mailpiece is acquired by at least one data acquisition unit and the mailpieces are sorted among various delivery districts on the basis of the acquired destination information. Subsequently, the mailpiece is transported to a second mail distribution center that is located in the applicable delivery district and that then serves as the incoming mail center.

For instance, a rough sorting of incoming mailpieces according to destinations of mail distribution centers is carried out in an outgoing mail center. The sorted mailpieces are transported to various destination mail distribution centers where they undergo fine sorting, for example, according to street names and house numbers. After the fine sorting, the mailpieces are given to a deliverer for a specific delivery run. Thus, each mail distribution center functions as an outgoing mail distribution center when it distributes the dropped-off mailpieces to other mail distribution centers, and also as an incoming mail distribution center when it sorts the mailpieces received from other mail distribution centers so that they can then be delivered.

In an exemplary embodiment of the invention, it is provided that different data is acquired in an outgoing mail center than in a destination incoming mail center, or that data already acquired in the IMC only has to be confirmed one more time. However, data is additionally transmitted between both mail distribution centers.

The division of the various steps among two mail distribution centers 20′ and 20″ during the processing of the destination information about mailpieces is described by way of an example with reference to FIG. 2. The devices shown within the mail distribution centers in FIG. 2, however, can execute the process steps for an incoming mailpiece as well as for an outgoing mailpiece. Therefore, when mailpieces arrive at location B, the mail distribution center 20″ located there becomes the outgoing mail center and the functions of the components and connections shown in FIG. 2 change accordingly.

In the exemplary embodiment shown in FIG. 2, a mailpiece 40 is provided with an unambiguous mailpiece identification 41. Preferably, this mailpiece identification 41 is an address in plain text and/or at least a barcode containing encrypted information that unambiguously identifies the mailpiece in the system. Instead of a barcode, three-dimensional matrices or information in plain text can also be used for purposes of unambiguously identifying the mailpiece. It is likewise possible to identify a mailpiece by using an RID transponder.

The mailpiece 40 is typically a parcel which, due to its dimensions, does not fit into the mailbox of a recipient, so that the recipient can choose instead to have it delivered to an electronic parcel compartment facility 10. The customer, however, can also select delivery to a parcel compartment facility for other types of mailpieces such as letters, books or merchandise so that the invention is not limited to the processing of parcels. Thus, the possibility exists, for example, for a customer to arrange to have mailpieces sent to any desired parcel compartment facility that is nearby, for example, when he/she is traveling for business or on vacation.

In a practical manner, there is at least one parcel compartment facility situated in the area of each mail distribution center. It is more advantageous, however, to arrange several parcel compartment facilities in the area of a mail distribution center or of a city so that as many places for deliveries as possible can be provided for customers.

Parcel compartment facilities can normally be used by registered and/or non-registered recipients of mailpieces. If re-routing instructions given by a recipient are to be taken into consideration for the delivery, it has proven to be advantageous for the customer to be registered.

If parcels are transported and delivered within the system, the destination information 11 is located, for example, on a label that has been applied onto the parcel. The label can be applied by the sender himself/herself, by a post office and, in individual cases, also by a mail distribution center. A barcode on the label serves to unambiguously identify the mailpiece, thus making it possible to track the mailpiece in the system.

After the mailpiece 40 has been received in the mail transportation and distribution system, the mailpiece is transferred to a first mail distribution center 20′ which then functions as an outgoing mail center for this mailpiece. At the outgoing mail center, a reading device 22′ reads the destination information on the mailpiece. Moreover, information that unambiguously identifies the mailpiece in the system is read. This information will also be referred to below as the parcel ID. The parcel ID can already be present on the mailpiece or else it is generated by the data processing unit 21′ of the mail distribution center 20′ and applied onto the mailpiece. It can be, for example, a barcode that is printed onto the mailpiece.

The reading device 22′ is, for instance, a parcel-address reading system, or else, individual processing stations in a mail distribution center read information from mailpieces and transmit this to a central computer in the mail distribution center. If a barcode is used to identify a mailpiece, the information is read with a scanner. In contrast, if an RFID transponder is used, then the information stored in it is acquired by using an associated reading device.

Moreover, the reading device 22′ can ascertain information about the recipient of the mailpiece. This information can be acquired, for instance, by OCR reading devices and then processed by the data processing unit 21′. In an exemplary embodiment of the invention, a recipient identifier is applied onto the mailpiece and it can be machine-read by the reading device. This identifier is, for example, the customer ID of a recipient who is registered in the system.

The customer ID can likewise be applied onto the mailpiece in encrypted form or in plain text. For instance, the customer ID of a recipient was indicated when merchandise was ordered, so the sender can apply the customer ID onto the mailpiece in the area of the address field in order to send it. If no customer ID has been applied, then, for example, the customer name and address that are present in plain text on the mailpiece can be read. Moreover, additional address information such as street name, house number, postal code or the dimensions of a mailpiece is acquired and processed by various systems.

The ascertained or generated parcel ID is sent together with information about the recipient to the data processing unit 30 that is in communication with the outgoing mail center 20′. The data processing unit has access to a customer database 32 where re-routing instructions provided by the customer are stored.

The data processing unit 30 queries the database 32 as to whether re-routing instructions have been stored for the acquired customer ID. These are preferably instructions to the effect that a mailpiece should be delivered to a parcel compartment facility selected by the customer. In this context, the customer may have submitted several delivery routines, so that different parcel compartment facilities can be indicated for different periods of time.

If the mailpiece was originally addressed to the home address of the customer, the mailpiece is then re-routed to a parcel compartment facility. Even if the mailpiece had already been addressed to a parcel compartment facility before, the mailpiece can re-routed to a different parcel compartment facility if the customer has submitted this.

Moreover, the current capacities of the parcel compartment facilities can be taken into consideration for the re-routing of the mailpiece in that the data processing unit 30 accesses the memory 31 in which the occupation status of all of the parcel compartment facilities is stored. If the customer has selected a parcel compartment facility, but the system knows that no free compartments are available in that particular parcel compartment facility, for example, an alternative parcel compartment facility that has available compartments can be selected.

On the basis of the re-routing instruction of the customer in conjunction with the read customer ID, destination information is ascertained and this destination information is associated with the unambiguous identification (parcel ID) of the mailpiece. Subsequently, the mailpiece is then assigned to the mail distribution center in whose area the destination—and consequently the electronic parcel compartment facility—is located and to which the mailpiece is supposed to be re-routed.

The mail distribution center 20″ then functions as the incoming mail center for this mailpiece. The mailpiece is transported by a transportation device such as, for example, trains or trucks, to the incoming mail center 20″ in question, where it is accepted. Moreover, the data processing unit 21′ of the outgoing mail center 20′ associates the destination information with the appertaining parcel ID of the shipment. At least the information about the destination and the parcel ID are transmitted via a data line to an appropriate data processing unit 21″ that is in communication with the destination incoming mail center 20″. It can also be provided that additional information such as street name, house number, postal code or the dimensions of the mailpiece is likewise transmitted to the data processing unit 21″ of the incoming mail center 20″.

If the parcel ID of the mailpiece is once again scanned by a reading device 22″ in the incoming mail center 20″, the data processing unit 21′ associates the mailpiece with the applicable destination information and the mailpiece is sorted on the basis of this destination information in such a way as to be assigned to a deliverer and to a delivery district where the appertaining parcel compartment facility 10 is located.

Also in those cases where the recipient has arranged for different time periods for the delivery to different parcel compartment facilities, the possibility exists that the destination information of a mailpiece might change once again after the first re-addressing. Advantageously, after the parcel ID has been acquired, the data processing unit 21″ in the incoming mail center once again queries the database 32 of the central management unit 30 in order to inquire about the current specifications for a re-routing. If, for instance, the transportation of the mailpiece from the outgoing mail center to the incoming mail center has been delayed, it can happen that a certain time window will have been exceeded and the recipient now wants the delivery to be made to a different parcel compartment facility. In this case, the mailpiece is re-routed once again.

The X number of mailpieces recorded within a prescribed period of time Z whose destination information matches the parcel compartment facility can be determined in the first outgoing mail center 20′ or in the second incoming mail center 20′. Moreover, the period of time Z can be selected in such a way that mailpieces are counted at an earlier or later stage during the delivery process. If the number of mailpieces projected for a parcel compartment facility on a given day is to be counted as exactly as possible, the period of time Z is selected in such a manner that that all of the addressed directly and all of the re-routed mailpieces are counted. This can also include the counting of mailpieces that have been re-addressed at a very late point in time after yet another checking procedure in the incoming mail center.

The deliverer transports the mailpiece 40 to the parcel compartment facility 10 and deposits the mailpiece into a free compartment there. The customer can likewise be notified by the central management unit 30 that the mailpiece has been deposited as soon as the parcel compartment facility 10 has informed the management unit that a mailpiece has been deposited into the compartment. The customer can be notified, for instance, by e-mail or by SMS.

In an exemplary embodiment of the invention, already before the mailpiece is deposited, the customer is notified in advance that the mailpiece will be deposited into a parcel compartment facility in the near future. This advance notification can be initiated, for example, as soon as the mailpiece has been assigned in the outgoing mail center to a destination in the form of a parcel compartment facility. Since, at this point in time, it cannot yet be ascertained whether a mailpiece will actually reach the incoming mail center in question, it can be advantageous to only send the advance notification to the customer once the mailpiece has been scanned once again at the incoming mail center. After the mailpiece has been deposited into the parcel compartment facility, the customer receives a notification confirming that the mailpiece has indeed been deposited.

If it is provided that the destination for re-routing a mailpiece can change over the course of the transportation and distribution route, several advance notifications can be sent to the customer indicating that said mailpiece will be deposited. For example, the central management unit 30 might receive from a customer a one-time instruction that a given mailpiece should be re-routed even if that mailpiece has already been scanned at the outgoing mail center and conceivably might even already be en route to an incoming mail center. The new re-routing instruction is transmitted by the central management unit to the data processing unit 21″ of the incoming mail center 20″. As soon as the parcel ID of the mailpiece is read in at the incoming mail center, the mailpiece is assigned to a new destination and the mailpiece is sorted accordingly.

If a reservation has already been made for a compartment in a parcel compartment facility, this reservation is cancelled and, if possible, a compartment is reserved in the newly specified parcel compartment facility. If it turns out that there are no free compartments in the parcel compartment facility that had been newly specified by the customer, advantageously, re-addressing of the mailpiece is not carried out and the customer is notified to this effect.

A mailpiece can be re-addressed once again to parcel compartment facilities in the area of the incoming mail center that had been specified first or else outside of this area. In the case of re-addressing within the area of the incoming mail center, the mailpiece is merely assigned to a new parcel compartment facility and it is assigned to another delivery run. If the mailpiece is to be re-addressed to a place at a distance from the incoming mail center because the customer, for example, wishes the delivery to be made to another large city, then the pertinent mail distribution center of this city is ascertained and the mailpiece is transported to that mail distribution center. The newly specified mail distribution center now functions as the incoming mail center and the steps of the method according to the invention can be carried out analogously there.

In an exemplary embodiment of the invention, a shipment notice is sent to a parcel compartment facility 10 if it is ascertained in an outgoing mail center 20′ that a mailpiece is intended for a parcel compartment facility. This mailpiece can be one addressed directly to a parcel compartment facility and it can also be a mailpiece that has been re-routed. Therefore, in addition to the reservation of a compartment for a given user group, mailing-specific data is also transmitted to the parcel compartment facility. The data acquired at the outgoing mail center 20′ such as customer ID, parcel ID, street name, house number, postal code or the dimensions of the mailpiece can be transmitted directly to the appertaining parcel compartment facility 10 or else via the central management unit 30 and stored in a memory of the parcel compartment facility. When a mailpiece is deposited into a parcel compartment facility, the parcel ID is acquired and the appertaining data record is called up.

For instance, the deliverer scans the barcode of a mailpiece, and it is then ascertained whether a free compartment has been reserved for the deliverer or for the mailpiece. If this is the case, the automatic facility recognizes the mailpiece on the basis of the parcel ID and displays the relevant data of the mailing data record on a screen. Advantageously, the displayed data includes at least the customer ID and the name of the recipient. Optionally, it is also possible for information regarding requisite COD payments to be displayed. Therefore, the deliverer does not have to enter this data himself, but rather, it is already available to him when a mailpiece is deposited and all he/she has to do is to confirm it. This simplifies the delivery and considerably reduces the delivery time.

The information provided about the dimensions serves as the basis to determine how many compartments and in which size will be needed on that day. The appropriate compartment sizes can be reserved for these mailpieces. In addition, mailpieces that cannot be placed into the automatic parcel facilities because of their dimensions are identified at an early point in time and can be re-routed, for example, to a post office branch. For instance, if it is ascertained at the outgoing mail center that a parcel is addressed to a given parcel compartment facility but that there are no compartments of an adequate size available there, the parcel can be re-routed. Then the parcel can be re-routed to a post office branch or to the home address of the recipient.

Mailing data can also be acquired at the incoming mail center. In contrast, however, the acquisition at the outgoing mail center has the essential advantage that that data is already present in the system at the earliest possible point in time and thus can be used for a mailing notice and for capacity planning. In the incoming mail center, only the parcel ID is once again scanned and the appertaining data is loaded. This means that the procedures during the processing of the mailpiece at the incoming mail center can be carried out more quickly. The relevant contents of the acquired data are transmitted to the incoming mail center and the outgoing mail center then merely confirms that a given mailpiece has arrived at the incoming mail center (IMC).

Therefore, mailing data can be acquired at different points in time over the course of the delivery process of a mailpiece that has been addressed to a parcel compartment facility either directly or through re-routing instructions. The delivery process itself can also be carried out by several mail distribution centers. Based on a count of the mailpieces during an applicable period of time, compartments are reserved for a first user group A. The reservation can also include a shipment notice to the parcel compartment facility in question. All of the remaining free compartments of a facility are given to other user groups according to a defined system.

Therefore, another aspect is that the data processing unit or control unit of a parcel compartment facility 10 determines a point in time P at which all of the reservations are cancelled. For instance, it can be provided that reservations are held until noon, after which they are then cancelled, so that the remaining free compartments are available to all other user groups in the afternoon. Whereas reservations are taken into account in the morning, especially in order to ensure that mailpieces addressed directly to the parcel compartment facility can be deposited, the principle employed in the afternoon for a free compartment is that of “first come, first served”. Consequently, individual user groups are no longer given preferential treatment or receive more compartments than other user groups, but rather, the remaining compartments are distributed among all other users on an equal basis. Furthermore, compartments can be utilized by several user groups. For example, the end customer can deposit returns into compartments that are reserved for the user group of the deliverers since the latter have to remove these returns.

The point in time P can be permanently stored in the control unit of the parcel compartment facility 10 or else it is set variably by the central data processing unit 30 every day and transmitted as a signal to the parcel compartment facility. For instance, it can be provided that the point in time P is specified by the data processing unit 30 as a function of the X number of compartments that have been reserved for the user group A. Moreover, the point in time can be specified as a function of the day of the week or of the total number of deliveries that are expected from a deliverer within a delivery district. At times of high mail volumes such as, for instance, during the holiday season, the point in time can be set very late in order to the give the deliverer sufficient time to deposit the mailpieces before the needed reservations are cancelled.

The point in time P can also be selected as a function of the location of the particular parcel compartment facility or of the reserved compartments that have already been occupied. In an exemplary embodiment of the invention, the reservations are cancelled, for instance, as soon as all of the compartments of user group A have been filled by the appertaining deliverers. Up until that point in time, other user groups are also given priority according to their reservations, after which, however, all of the remaining reservations are cancelled.

### LIST OF REFERENCE NUMERALS

10 parcel compartment facility
11 compartment
12 user interface
20 mail distribution center (MDC)
20′ outgoing mail center (OMC)
20″ incoming mail center (IMC)
21 data processing unit in the MDC
21′ data processing unit in the OMC
21″ data processing unit in the IMC
22 data acquisition unit, OCR reading device, scanner
22′ data acquisition unit in the OMC
22″ data acquisition unit in the IMC
30 central data processing unit, DPU
31 memory
32 database, customer database
40 mailpiece, parcel
41 mailing information

1-8. (canceled)

9. A method for operating at least one electronic parcel compartment facility comprising several compartments in a number amounting to F, with which mailpieces of at least two user groups A and B having different access rights can be deposited into the compartments of the parcel compartment facility, whereby the parcel compartment facility is in communication with a central data processing unit, and the occupation status of the compartments of the parcel compartment facility is transmitted to the data processing unit so that the number Y of different sizes of free compartments of the parcel compartment facility is stored in a memory of the data processing unit, and the central data processing unit is also in communication with at least one mail distribution center where destination information about the mailpieces is acquired, whereby the destination information is associated with the parcel compartment facility, the method comprising:
specifying a period of time Z between a starting point in time and an ending point in time;
storing the period of time Z in a data processing unit of the mail distribution center;
acquiring destination information and sizes of the mailpieces in the mail distribution center using a data acquisition device;
determining the X number of mailpieces whose destination information acquired during the period of time Z matches the destination information of the parcel compartment facility by the data processing unit of the mail distribution center;
transmitting the number X by the data processing unit of the mail distribution center to the central data processing unit;
comparing the number X to the number Y of free compartments;
assigning X free compartments of the parcel compartment facility to a first user group A by the central data processing unit if Y≧X;
transmitting a control command for the reservation of the X free compartments of the parcel compartment facility assigned to the first user group A by the data processing unit to a control unit of the parcel compartment facility;
subtracting the number X of reserved compartments from the number Y of free compartments for purposes of determining the number V of available compartments remaining in the parcel compartment facility;
assigning at least some of the remaining available compartments V to a second user group B, if V>1;
transmitting a control command for a reservation of the compartments assigned to the second user group B from the data processing unit to the control unit of the parcel compartment facility;
acquiring user identifications and/or mailing information through a user interface at the parcel compartment facility;
associating a user and/or a mailpiece with the user groups A or B on the basis of the acquired user information and/or mailing information;
controlling access to free compartments of the parcel compartment facility on the basis of the reservations made for the two user groups A and B;
determining a point in time P by the control unit of the parcel compartment facility;
canceling the reservations of compartments for the user groups A and B after the point in time P; and
releasing access to free compartments of the parcel compartment facility to all user groups.

10. The method recited in claim 9, wherein mailpieces of three user groups A, B and C can be deposited into the compartments of the parcel compartment facility, the method comprising:
assigning a first portion of the remaining available compartments V to the second user group B; and
assigning a second portion of the remaining available compartments V to a third user group C.

11. The method recited in claim 10, wherein the remaining available compartments V are assigned to the user groups B and C in equal proportions.

12. The method recited in claim 10, wherein the remaining available compartments V are assigned to the user groups B and C in unequal proportions.

13. The method recited in claim 9, wherein the point in time P is permanently stored in the control unit of the parcel compartment facility.

14. The method recited in claim 9, wherein the point in time P can be specified variably as a function of various parameters.

15. The method recited in claim 9, wherein the point in time P is specified by the central data processing unit and transmitted to the control unit of the parcel compartment facility.

16. An arrangement of devices to operate at least one electronic parcel compartment facility comprising several compartments in a number amounting to F, with which mailpieces of at least two user groups A and B having different access rights can be deposited, whereby the parcel compartment facility is in communication with a central data processing unit that encompasses a memory to store the occupation status of the compartments of the parcel compartment facility, so that the number Y of different sizes of free compartments of the parcel compartment facility can be stored, and the central data processing unit is also in communication with at least one mail distribution center that has at least one data acquisition device to acquire destination information and the size of mailpieces, and a data processing unit, whereby the destination information is associated with the parcel compartment facility, the arrangement of devices comprising:
a device associated with the data processing unit that is adapted to specify a period of time Z between a starting point in time and an ending point in time, the period of time Z being stored in a memory in the data processing unit;
a device associated with the data processing unit that is adapted to determine the X number of mailpieces whose destination information acquired during the period of time Z matches the destination information of the parcel compartment facility;
a transmitter that is adapted to transmit the number X to the central data processing unit;
a device associated with the parcel compartment facility that is adapted to transmit the occupation status of the compartments F to the central data processing unit;
a device associated with the parcel compartment facility that is adapted to receive control signals from the data processing unit in order to reserve compartments for at least two user groups A and B;
a user interface associated with the parcel compartment facility to acquire user information and/or mailing information;
a device associated with the parcel compartment facility that is adapted to associate users and/or mailpieces with the user groups A or B;
a device associated with the parcel compartment facility that is adapted to release free compartments on the basis of reserves made for the user groups A and B;
a device associated with the parcel compartment facility that is adapted to specify a point in time P;
a device associated with the parcel compartment facility that is adapted to cancel reservations at the point in time P;
a device associated with the central data processing unit that is adapted to compare the number X to the number Y of free compartments;
a device associated with the central data processing unit that is adapted to associate the Y free compartments of the parcel compartment facility with the at least two user groups A and B;
a device associated with the central data processing unit that is adapted to generate control commands for the reservation of compartments of the parcel compartment facility; and
a device associated with the central data processing unit that is adapted to transmit these control commands to the parcel compartment facility.

17. An electronic parcel compartment facility comprising several compartments in a number amounting to F, with which mailpieces of at least two user groups A and B having different access rights can be deposited into the compartments of the parcel compartment facility, whereby the electronic parcel compartment facility is in communication with a central data processing unit, and the occupation status of the compartments of the electronic parcel compartment facility is transmitted to the data processing unit so that the number Y of different sizes of free compartments of the electronic parcel compartment facility is stored in a memory of the data processing unit, and the central data processing unit is also in communication with at least one mail distribution center where destination information about the mailpieces is acquired, whereby the destination information is associated with the electronic parcel compartment facility, the electronic parcel compartment facility comprising:
means for specifying a period of time Z between a starting point in time and an ending point in time;
means for storing the period of time Z in a data processing unit of the mail distribution center;
means for acquiring destination information and sizes of the mailpieces in the mail distribution center using a data acquisition device;
means for determining the X number of mailpieces whose destination information acquired during the period of time Z matches the destination information of the parcel compartment facility by the data processing unit of the mail distribution center;
means for transmitting the number X by the data processing unit of the mail distribution center to the central data processing unit;
means for comparing the number X to the number Y of free compartments;
means for assigning X free compartments of the parcel compartment facility to a first user group A by the central data processing unit if Y≧X;
means for transmitting a control command for the reservation of the X free compartments of the parcel compartment facility assigned to the first user group A by the data processing unit to a control unit of the parcel compartment facility;
means for subtracting the number X of reserved compartments from the number Y of free compartments for purposes of determining the number V of available compartments remaining in the parcel compartment facility;
means for assigning at least some of the remaining available compartments V to a second user group B, if V>1;
means for transmitting a control command for a reservation of the compartments assigned to the second user group B from the data processing unit to the control unit of the parcel compartment facility;
means for acquiring user identifications and/or mailing information through a user interface at the parcel compartment facility;
means for associating a user and/or a mailpiece with the user groups A or B on the basis of the acquired user information and/or mailing information;
means for controlling access to free compartments of the parcel compartment facility on the basis of the reservations made for the two user groups A and B;
means for determining a point in time P by the control unit of the parcel compartment facility;
means for canceling the reservations of compartments for the user groups A and B after the point in time P; and
means for releasing access to free compartments of the parcel compartment facility to all user groups.
